(19) United States
(12) Patent Application Publication
(10) Pub. No.: US 2026/0221802 A1
(43) Pub. Date: Jul. 30, 2026

(54) POWER TRANSFORMER DIGITAL LOGGER

(71) Applicant: SAUDI ARABIAN OIL COMPANY, Dhahran (SA)

(72) Inventors: Awadh M. Gahtani, Dammam (SA); Meshari S. Otaibi, Dhahran (SA); Abdullah A. Issa, Dammam (SA)

(73) Assignee: SAUDI ARABIAN OIL COMPANY, Dhahran (SA)

(21) Appl. No.: 19/039,127

(22) Filed: Jan. 28, 2025

(51) Int. Cl. H02J 13/00; G06N 3/09

(52) U.S. Cl. CPC H02J 13/12; G06N 3/09; H02J 13/10; H02J 13/1335

(57) ABSTRACT

Method and system for a digital device disposed inside an enclosure on a transformer. The digital device includes a testing manager, a user interface, and a transmitter. The testing manager obtains operational data of the transformer including historical transformer data and current transformer data, obtains a test type and a test result of a test performed on the transformer, and determines, via a test verification model, a verification test result including a pass or fail diagnosis for the transformer based on the operational data and the performed test. The testing manager further determines, via a predictive model including an artificial intelligence model, a forecasted performance evaluation based on the operational data and generates a digital report including the test type, the test result, the verification test result, and the forecasted performance evaluation. The forecasted performance evaluation includes an alert regarding failure anticipation of the transformer.

### BACKGROUND

In the petroleum industry, transformers are considered essential for providing reliable and stable power supply to critical equipment. Therefore, inspection of transformers is important for ensuring longevity and optimal performance of an electrical system. The conventional inspection process of power transformers involves visual inspections from an inspector and, sometimes, manual execution of a test and creation or updating of an associated record, for example, a log book of the inspector. The conventional inspection process is susceptible to human error and results in the dispersing of information or data relevant to transformers and their inspections over scattered data warehouses.

Scattered data warehouses cause difficulty in retrieving and tracing data. Technician and inspector capabilities are relied on to evaluate and judge test results based on industry codes and mandatory requirements, such as organization-specific engineering requirements. Further, these conventional processes, already subjected to human error, make use of hardcopy records, where the use of these hardcopy records can cause late submissions and project delays, paper waste, and falsification attempts. Furthermore, there is no baseline comparison between manufacturer and operation and maintenance (O/M) test results to provide test result notifications.

Accordingly, there exists a need for a power transformer digital logger system that improves monitoring efficiency of transformer integrity through transformer life cycle.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a digital device, comprising: a testing manager comprising a computer processor, wherein the testing manager is configured to: obtain, via a database in the digital device, operational data of a transformer comprising historical transformer data and current transformer data for the transformer; obtain a test type and a test result of a test performed on the transformer; determine, via a test verification model, a verification test result comprising a pass or fail diagnosis for the transformer based on the operational data and the performed test; determine, via a predictive model comprising an artificial intelligence (AI) model, a forecasted performance evaluation based on the operational data, wherein the forecasted performance evaluation comprises an alert regarding failure anticipation of the transformer; and generate a digital report comprising the test type, the test result, the verification test result, and the forecasted performance evaluation; and a user interface comprising a display; and a transmitter configured to transmit the digital report, wherein the digital device is disposed inside an enclosure on the transformer.

In one aspect, embodiments disclosed herein relate to a method for inspecting a transformer, the method performed by a digital device installed with the transformer, comprising: obtaining, via a database in the digital device, operational data of the transformer comprising historical transformer data and current transformer data for the transformer; obtaining a test type and a test result of a test performed on the transformer; determining, via a test verification model, a verification test result comprising a pass or fail diagnosis for the transformer based on the operational data and the performed test; determining, via a predictive model comprising an artificial intelligence (AI) model, a forecasted performance evaluation based on the operational data, wherein the forecasted performance evaluation comprises an alert regarding failure anticipation of the transformer; generating a digital report comprising the test type, the test result, the verification test result, and the forecasted performance evaluation; transmitting, via a transmitter of the digital device, the digital report to a user; and displaying the digital report via a user interface on the digital device.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows an environment with a transformer in accordance with one or more embodiments.

FIG. 2 shows a digital device in accordance with one or more embodiments.

FIG. 3 shows an example digital device in accordance with one or more embodiments.

FIG. 4 depicts an example graphical user interface in accordance with one or more embodiments.

FIG. 5 depicts an example graphical user interface in accordance with one or more embodiments.

FIG. 6 depicts an example graphical user interface in accordance with one or more embodiments.

FIG. 7 shows a computer system in accordance with one or more embodiments.

FIG. 8 shows a flowchart in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure describe a transformer digital logger system with a digital device installed on a transformer. The transformer digital logger system has the capability of recording the entirety of an equipment or transformer's life cycle test activities. The test activities may occur during manufacturing, installation and operation, and maintenance stages of the equipment or transformer. The transformer digital logger system may be utilized on any type of transformer and is not limited to transformers used in the oil and gas industry. The transformer digital logger system includes a built-in database for verifying test results and providing test result notifications to designated personnel using automatically generated digital reports. The system uses artificial intelligence (AI) to predict failures, determine or recommend maintenance requirements, and estimate or predict the life expectancy of the equipment (i.e., transformer).

For example, a user performs a test on the equipment that is logged and verified on the digital device. The digital device displays the date of the last test performed, the test results, and whether the test result is verified. The transformer digital logger system utilizes the logged information to diagnose and predict failures of the equipment. The digital device then displays and/or sends a generated digital report to a user including all desired information.

Advantages of embodiments disclosed herein include a data warehouse traceability system for recording all test activities and AI powered solutions for executing pass and fail results of the equipment. Advantages further include a user-friendly interface for generating automatic digital reports to prevent data falsification and ensure required tests are executed correctly thereby minimizing rework and forgery attempts. Advantages further include network connections for transmitting test result notifications to a user via email or other communication methods.

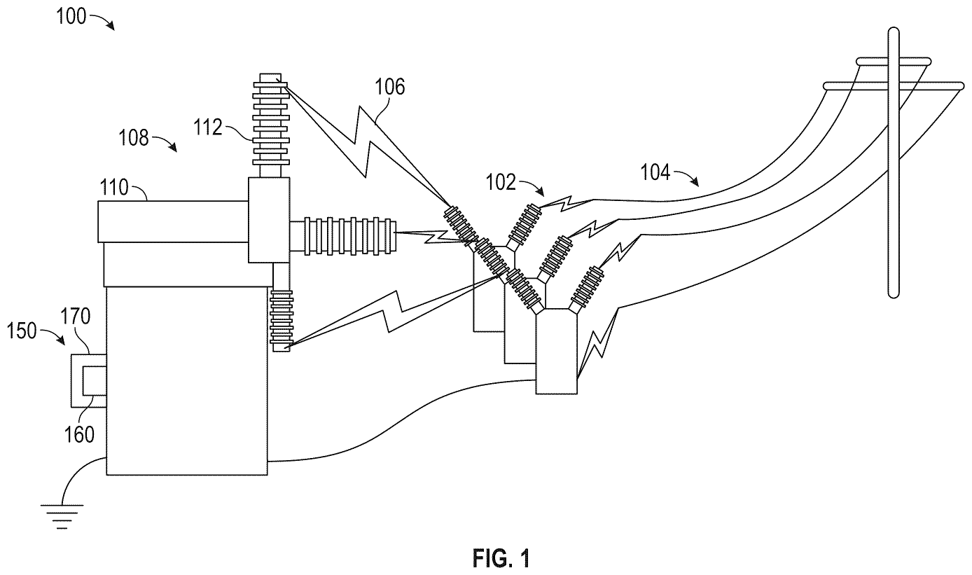

FIG. 1 shows an environment (100) in accordance with one or more embodiments. A high voltage power system (“HV system”) (108) has a high voltage transformer (“HV transformer”) (110) with an HV transformer high-voltage side and is located at a substation site (102) of an electrical power transmission and distribution system (“TD system”) (104). HV transformer (110) of HV system (108) may be electrically connected to the TD system (104) through power lines (106). HV transformer (110) may use a bushing (112) connection points between power lines (106) and HV transformer (110). An HV transformer may be a voltage converter defined as 1000 Vac (volts, alternating current) at 50 or 60 Hz (hertz) frequency. Although embodiments disclosed herein are discussed in relation to HV transformers, this is not intended to be limiting. In general, embodiments disclosed herein can be used with any type of transformer, AC or DC, or similar electrical apparatus, e.g., machinery, switchgear, installation, or reactor. For example, the transformer may be a medium voltage AC transformer, a DC transformer, a reactor, or an oil circuit breaker, etc.

In some embodiments, the HV transformer (110) includes a transformer digital logger system (150). The transformer digital logger system (150) includes a digital device (160) installed on the HV transformer (110). The digital device (160) is protected by an enclosure (170) covering the digital device (160) on the HV transformer (110). A person of ordinary skill in the art would appreciate that in some embodiments, the enclosure (170) is an ingress protection (IP) enclosure rated at 66 to protect the digital device (160) from dust and/or water. Although only the IP 66 enclosure is specified in these embodiments, those skilled in the art will appreciate that the enclosure (170) may be any enclosure designed to be dust and/or waterproof.

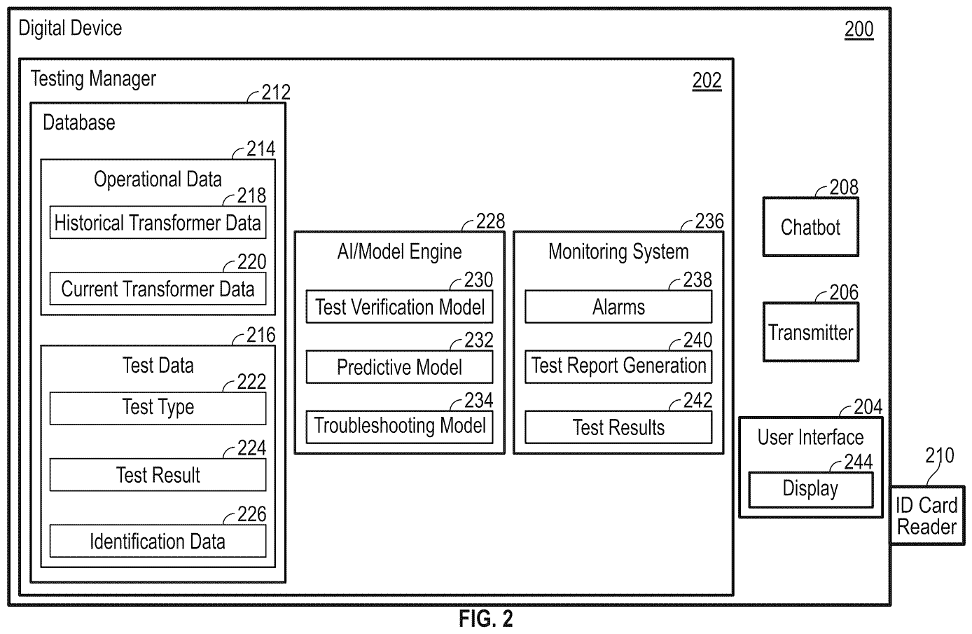

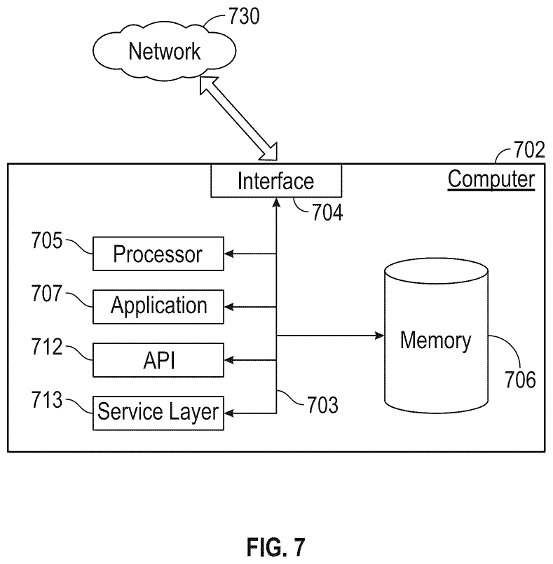

FIG. 2 shows a digital device (200) in accordance with one or more embodiments. The digital device (200) (i.e., digital device (160)) can be used in conjunction with a transformer, such as HV transformer (110) described in FIG. 1. Digital device (200) may be battery powered or electrically powered. In accordance with one or more embodiments, digital device (200) includes a testing manager (202), a user interface (204)), and a transmitter (206). In some embodiments, digital device (200) further includes a chatbot (208) feature and/or an identification (ID) card reader (210). The testing manager (202) includes a computer processor for computing capabilities, such as the computer processor (705) further discussed in FIG. 7. The test manager (202) includes a database (212) that stores operational data (214) and test data (216). Operational data contains historical transformer data (218) and current transformer data (220). For example, operational data (214) may include current or historical test data from one or more transformers of interest. Historical and current transformer data (218, 220) may include any parameter or data relating to any component of the transformer. Components of the transformer may include but are not limited to a core, windings, insulation, brushing, tap changer, terminals, cooling tubes, transformer tanks, breathers, explosion vent, Buchholz relay, oil tanks, winding taps, oil conservator, etc.

In one or more embodiments, test data includes test type (222) and test result (224) from a test performed on the transformer. A person of ordinary skill in the art will appreciate that tests performed on the transformer may be any type of inspection test known in the industry. For example, inspection tests include but are not limited to winding resistance tests, transformer ratio tests, insulation resistance tests, dielectric tests, temperature rise tests, polarity tests, insulating oil tests, voltage ratio of all taps tests, three-phase wiring group tests, insulation resistance of fasteners tests, on-load voltage regulation switching device tests, etc.

In some embodiments, test data (216) further includes identification data (226) of the transformer. For example, identification data (226) can include information such as equipment number, inspector's name, and date/time (e.g., of a performed test or inspection). Identification data (226) may be uploaded using the ID card reader (210). The ID card reader (210) can further manage access of the user or inspector to the digital device by verifying the authenticity of an ID card and extracting information from the ID card. The ID card reader (210) may be any device or card reader that reads information from various types of cards or physical dongles and is designed to provide special access for easily retrievable data, such as test data (216) stored on the digital device 200. Although the ID card reader (210) is specifically noted as scanning ID cards, the ID card reader (210) may be programmed to read information from other cards, such as memory cards or radio frequency identification (RFID) tags. The ID card reader (210) may be connected to other computer systems or mobile devices for transferring data and performing other functions.

In one aspect, embodiments disclosed herein relate to an AI/model engine (228) in the testing manager (202) containing one or more of a mathematical model and an artificial intelligence model for determining verification test results and forecasted performance evaluations of a transformer (e.g., HV transformer (110)) based on operational data and performed tests on the transformer. As described in the instant disclosure, the operational data can include historical transformer data (218) and current transformer data (220), such as manufacturing data, installation and operation data, maintenance stage data, and/or periodic inspection results data. The testing manager (202) using the contained models (e.g., artificial intelligence model) processes given inputs such as the operational data (214) and test data (212) to produce verification test results, forecasted performance evaluations, and troubleshooting capabilities. In greater detail, the testing manager (202) utilizes the AI/model engine (228) including test verification model (230) and AI models (e.g., predictive model (232), and troubleshooting model (234)) for processing data, such as operational data (214) and test data. The testing manager (202) may further include a monitoring system (236) for monitoring alarms (238) and test results (242). The monitoring system (236) may include a test report generation (240) capability for a user.

In general, artificial intelligence (AI) encompasses a large body of algorithms, wherein the parameters of the algorithms are determined by evaluating a data set. AI algorithms are often categorized based on their intended function, the type and quantity of data they receive, and field of use. Common categorizations may include supervised learning, unsupervised learning, semi-supervised learning, and reinforcement learning. Additional categories, which are not exclusive to the aforementioned categories, may include computer vision (CV) and natural language processing (NLP). In many instances, AI algorithms are further categorized as regressors or classifiers. The AI/model engine (228) of the instant disclosure may make use of any known AI algorithm known in the art and future, not yet known but later developed AI or machine learning algorithms. For example, the AI/model engine (228) model types may include, but are not limited to, generalized linear models, Bayesian regression, random forests, and deep models such as neural networks, convolutional neural networks, transformers, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture”. Once an AI model type and hyperparameters have been selected, the AI model is trained to perform a task. In accordance with one or more embodiments, one or more AI model types and associated architecture are selected and trained to perform specific tasks such as sentiment analysis and anomaly detection.

In one or more embodiments, each of the artificial intelligence models (i.e., at least predictive model (232) and troubleshooting model (234)) is a supervised learning model trained using historical data. Operational data (214), in most instances, can be considered measurements of observable parameters of the transformer. In one or more embodiments, operational data (214) is acquired using devices of the equipment, such as resistance meters, ratio meters, or sensors. In accordance with one or more embodiments, the AI/model engine (228) includes, or has access to, database (212) for obtaining operational data (214) and test data (216). Historical transformer data (218) includes, at least, historical transformer data such as previous test reports, manufacturing records, installation records, and O&M records that can be used, when desired, to train (or re-train, fine-tune, etc.) the model and AI models.

As depicted in FIG. 2, the digital device (200) can further include a user interface (204), for example, with a display (244). The display (244) may be a touch screen. User interface (204) can be a graphical user interface. User interface (204) acts as the point of human-computer interaction and communication. Thus, user interface (204) can receive inputs from a user. Through the user interface (204), a user may upload forms. User interface (204) further provides visualizations, such as graphs, reports, and text and image data, to one or more users. In broad terms, user interface (204) can include display screens (i.e., display (244)), keyboards, and a computer mouse. In one or more embodiments, user interface (204) is implemented as a computer program, such as a native application or a web application.

As will be described, digital device (200) further enhances aspects of a transformer throughout its lifecycle by providing, among other things: an interactive and intelligent chatbot integrated into the user interface. FIG. 2 depicts a chatbot (208) as an independent entity, however, it is well understood that in practice the chatbot (208) may be implemented as part of the user interface (e.g., a “front end” coding effort) or part of the AI engine (228) (e.g., through a “back end” coding effort). The chatbot (208) is used to assist users in using digital device (200). In one or more embodiments, the chatbot (208) can directly receive and parse test, image, and audio data (e.g., through a microphone as part of the user interface (204)).

In general, a chatbot has access to one or more queries, where each query is associated with one or more input values of to be requested input data or input interactions received by or at the digital device from a user. In one or more embodiments, the relationship of queries and associated input values are defined by a set of query templates. The chatbot (208) identifies an input value that should be received from the user and prompts the user with an appropriate query. The user responds to a query with a response. The chatbot analyses the response and determines whether the desired input value(s) is contained in the response and further validates the input value(s) with a data validator. That is, the chatbot (208) both identifies a candidate input value in the response of the user and determines if the candidate input value is valid based on the pre-defined data type and set of acceptable values, if provided in the set of query templates. In many instances, the data validator used by the chatbot is configured with one or more data preprocessing and parsing algorithms (e.g., stemming, regular expressions, etc.) and/or natural language processing (NLP) models to properly handle text variations (e.g., capitalization), provide common mappings (e.g., month abbreviations to numeric values), and allow for data type coercion (e.g., floats to integers).

Based on the analysis of a response, the chatbot (208) can accept the input value or re-prompt the user. If the chatbot (208) determines that a user should be re-prompted for an input value, the chatbot (208) may re-use the query or propose a new query and/or provide aid or suggestions to the user, for example, detailing why the original response and input value(s) were not accepted. If an input value(s) is accepted by the chatbot (208), the chatbot (208) may provide the user with another query to obtain other input values. Note, that in some instances, subsequent queries selected by the chatbot (208) are determined based on previously received input values. The chatbot (208) may continue prompting the user with selected queries until the required input data has been received. The scope of the required input data may be altered according to the input value(s) received from the user. That is, based on received input value(s) the chatbot (208) may determine that other input values are no longer required and thus not prompt the user with the associated queries. Again, it is emphasized that the above description of a chatbot does not impose a limitation on the instant disclosure as various types of chatbots may be readily inserted into the framework disclosed herein.

In accordance with one or more embodiments, the chatbot (208), through interactions with users, is configured to intelligently adapt its queries to enhance the experience of the user. The chatbot (208) is not restricted to a pre-defined set of queries. The chatbot evaluates its interactions with users and based on the evaluation, can select different queries, alter existing queries, and/or generate queries to more efficiently extract desired information (input values) from its users while simultaneously enhancing user experience.

The chatbot (208) through its interactions with the user, for example through a set of queries and responses, can provide the user with relevant information, such as a process for correcting an error in the transformer (e.g., a specific troubleshooting guide). In some embodiments, recommendations are made to the user using the chatbot without queries based on the operational data 214, test data 216, outputs of the AI/Model engine 228, or combination thereof.

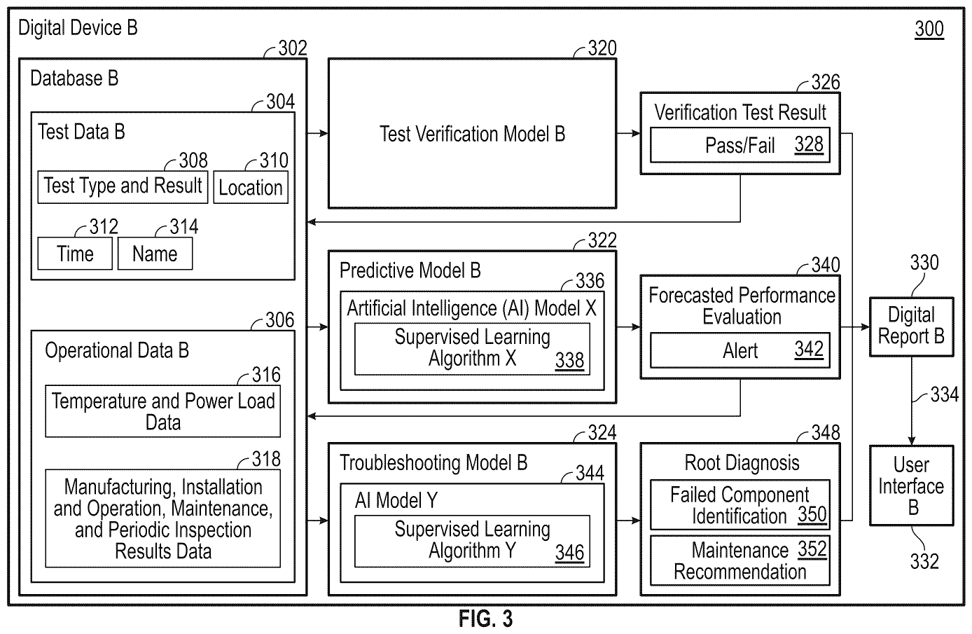

FIG. 3 shows an example instance of a digital device and interaction of its components or modules, in accordance with one or more embodiments. Specifically, FIG. 3 shows digital device B (300) for a transformer digital logger system that may be used in conjunction with FIG. 1. Similar to digital device (200) described in FIG. 2, digital device B (300) includes a database (e.g., database B (302)) containing test data (e.g., test data B (304)) and operational data (e.g., operational data B (306)). Test data B (304) includes current test type and results (308), location (310), time (312), and user's name (314) obtained for a transformer (e.g., HV transformer (110)) to which digital device B (300) is coupled. Operational data B (306) includes temperature and power load data (316) acquired for the coupled transformer. Operational data B (306) further includes manufacturing, installation and operation, maintenance, and periodic inspection results data (318) regarding the transformer. Operational data B (306) presents baseline data regarding the transformer.

Test data B (304) and operational data B (306) are input into test verification model B (320) and artificial intelligence models (e.g., predictive model B (322), and troubleshooting model B (324)) for processing. The digital device B (300) determines a verification test result (326) using the test verification model B (320) to output a pass or fail (328) diagnosis for the transformer. Verification test result (326) verifies test data B (304) based on baseline data and transformer data specifications in operational data B (306). Test verification model B (320) may act as an anomaly or outlier detection model. The pass/fail (328) diagnosis represents whether there is an anomaly in the data. For example, if temperature data varies by a predetermined value, the verification test result (326) will show fail. The verification test result (326) will be generated on digital report B (330). Digital report B (330) can be displayed on user interface B (332) or transmitted to another system (e.g., emailed to a user or relevant stakeholders associated with the transformer such as an operation personnel and/or safety personnel) using a transmitter (e.g., transmitter 206 in FIG. 2, not shown in FIG. 3) of the digital device. The transmitter can use a network connection (334) for transmitting digital report B (330).

In particular, the process involves identifying transformer test type, test time, location, and inspector's name (e.g., test data B (304)), inputting test data B (304) and operational data B (306) into test verification model B (320), determining verification test result (326), generating and transmitting digital report B (330), and emailing a notification to designated personnel of the digital report B (330) and/or displaying digital report B (330) on user interface B (332).

Predictive model B (322) uses a supervised learning algorithm X (338) in an AI model X (336) to determine a forecasted performance evaluation (340). The forecasted performance evaluation (340) can be used, for example, to predict failure of the transformer or failure of a component of the transformer. An alert (342) for the forecasted performance evaluation (340) is generated with digital report B (330) to be transmitted to user interface B (332). In one or more embodiments, the transmission of the alert (342) triggers the selection and application of one or more remedial actions to be applied to the transformer or affected area. For example, dependent on the severity and location of the predicted failure, remedial actions may include, but are not limited to: replacing the transformer, ordering components for the transformer, or fixing a component on the transformer. The alert (342) in digital report B (330) helps avoid expected failures for the equipment or transformer.

In one or more embodiments, the verification test result (326) and forecasted performance evaluation (340) are acquired by database B (302) for further processing. For example, troubleshooting model B (324) inputs the test data B (304) and operational data B (306) including the verification test result (326) and the forecasted performance evaluation (340) into a supervised learning algorithm Y (346) of an AI model Y (344). Digital device B (300) utilizes troubleshooting model B (324) for failed cases. For example, in response to a failed test result (i.e., test type and result (308)), a failed verification test result (i.e., pass/fail (328)), or a forecasted performance evaluation failure (i.e., alert (342)), the troubleshooting model B (324) determines a root diagnosis (348). The root diagnosis (348) includes failed component identification (350) and maintenance recommendation (352). For example, failed component identification (350) identifies which component failed or is predicted to fail. Maintenance recommendation (352) may include whether maintenance is required and/or a type of maintenance to perform on any given component. Digital report B (330) is generated to further include root diagnosis (348). Digital report B (330) is transmitted to user interface B (332) to be displayed to a user. At least the digital report B (330) is transmitted automatically and in real-time over a distributed network connection (334) or through a physical mechanism for data transfer, such as fiber optic cables, wireless fidelity (Wi-Fi), local area network (LAN), and Bluetooth. The digital report B (330) may be transmitted through email to designated personnel, quick response (QR) codes, or barcodes.

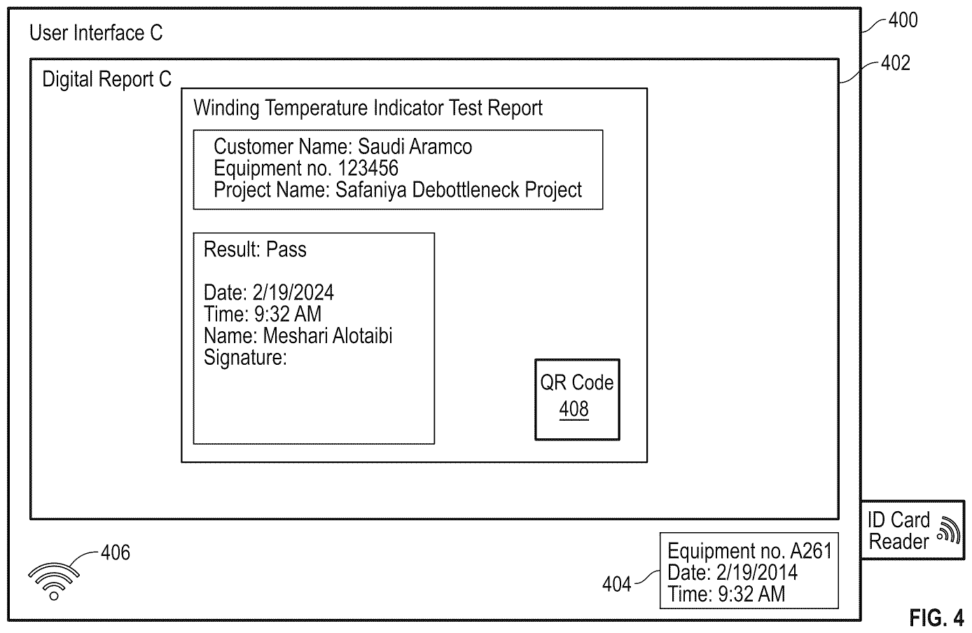

FIG. 4 depicts an example graphical user interface provided by the user interface (204), in accordance with one or more embodiments. As seen, in one or more embodiments, the example graphical user interface C (400) provides a digital report (e.g., digital report C (402)) and identification data (226) (e.g., identification data C (404)). In greater detail, identification data C (404) indicates the equipment number, current date and time, and previous date and time of a test performed on the transformer.

As described previously, digital reports (e.g., digital report B (330), digital report C (402)) are transmitted to a user through a transmitter (e.g., transmitter C (406)) or network connections, such as a QR code (408) displayed on the user interface (e.g., user interface C (400)). The authentication of the QR code (408) provides a tamper proof process ensuring required tests are executed correctly minimizing rework and forgery attempts.

As shown by FIG. 4, digital report C (402) displays a winding temperature indicator test report identifying customer name, equipment number, project name, pass result, data and time test performed, name of inspector, and signature of the personnel attending and signing the report.

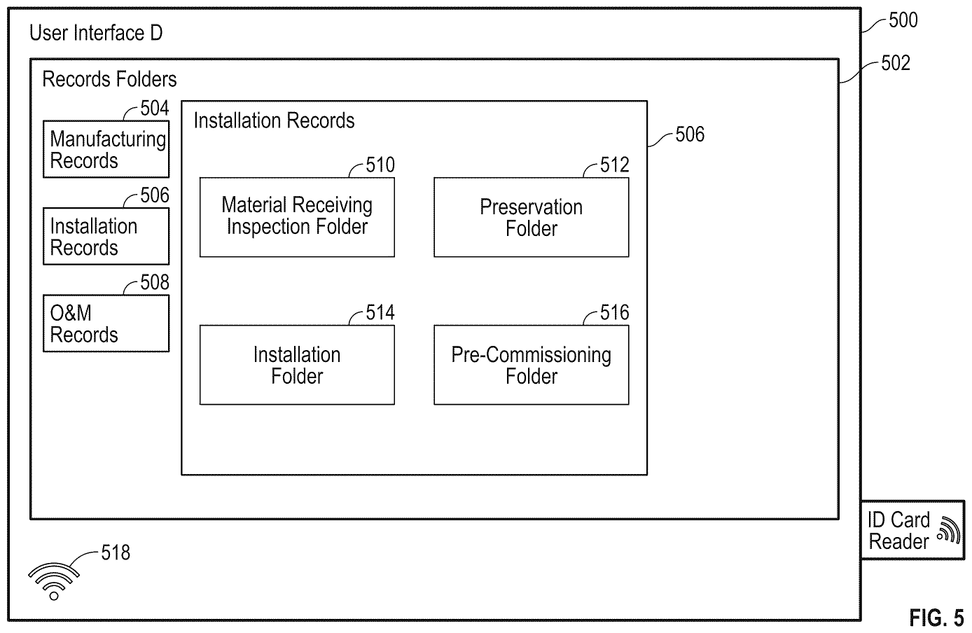

FIG. 5 depicts an example graphical user interface provided by the user interface (204), in accordance with one or more embodiments. As seen, in one or more embodiments, the example graphical user interface D (500) provides a menu with one or more buttons that directs users to specific resources, content, and/or other menus. User interface D (500) provides a convenient and user-friendly mechanism to access and organize the products of the digital device (e.g., digital device (160)) at any point during the lifecycle of a transformer. In one or more embodiments, for any given transformer, the digital device (160) can interact with any of the persons connected to the transformer according to their specific role, such as an inspector. Thus, the user interface D (500) may present a tailored interface for the users. For example, accessibility to content encompassed by the digital device (160) may be controlled through the user interface D (500) and user-access rights. As such, each user can interact with the digital device (160), simultaneously if needed, according to their specific needs.

In some embodiments, user interface D (500) displays a records folder (502) feature used to record test activities for the whole equipment's life cycle (during manufacturing, installation and operation &maintenance stages). As described previously (e.g., database (212), database B (302)), the records folder (502) includes multiple folders selections, such as manufacturing records (504), installation records (506), and O&M records (508), for a user to select. FIG. 5 specifically shows a selection of installation records (506) folder that displays four specified folders including material receiving inspection folder (510), preservation folder (512), installation folder (514), and pre-commissioning folder (516). By selecting any of the folders, data specific to the folder will display on user interface D (500). Although FIG. 5 specifies the documented folders, a user may input any given folder or data required. In some embodiments, a transmitter (e.g., transmitter D (518)) is used to transmit the contents of the records folders (502) to or from a user.

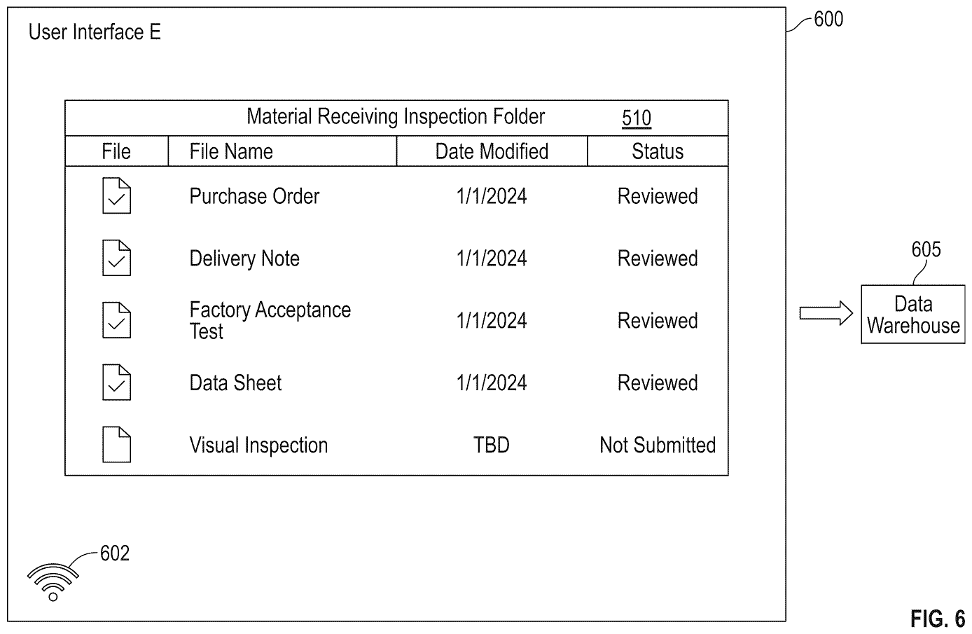

FIG. 6 depicts an example graphical user interface provided by the user interface (204), in accordance with one or more embodiments. As seen, in one or more embodiments, the example graphical user interface E (600) provides a display of selecting material receiving inspection folder (510) as described in FIG. 5 previously. Specifically, the material receiving inspection folder (510) displays obtained files, file names, date modified data, and status of each file. For example, the files include purchase order, delivery note, factory acceptance test, data sheet, and visual inspection. As shown by user interface D (500), the files with the status “reviewed” are check marked and the files with status “not submitted” do not have a check mark indicating attention needed.

In some embodiments, a transmitter (e.g., transmitter E (602)) or any of the previously described transmitters transmits data from the user interface (e.g., user interface E (600)) to an integrated data warehouse (605). The data warehouse (605) may be a data warehouse traceability system used for recording all test activities for the whole equipment's life cycle. Any and all data described in the previous embodiments, such as digital reports, test data, etc., may be transmitted to the data warehouse (605). The data warehouse (605) can store information for multiple transformers as received from their respective digital devices. Thus, in some embodiments, a plurality of digital devices, each paired or coupled with a transformer, are communicably coupled or connected to form a network, e.g., with the data warehouse (605). In some embodiments, aspects or modules of a digital device (200) such as the AI/Model Engine (228) (including the test verification model (230), predictive model (232), and troubleshooting model (234)) can make use of data or information stored in the data warehouse (605) in addition to data specific to the transformer stored in the database (212) of the digital device (200). For example, the troubleshooting module (234) can make use of operational data, test data, and logged maintenance operations of another digital device, where these data items are stored in and received from the data warehouse (605), to determine a recommended remedial action in view of the operational data (214) and/or test data (212) of the digital device (200). Continuing with this example, the operational data (214) of the digital device (200) can indicate an issue and this issue may have previously been observed and then resolved in another digital device by a remedial action. Thus, the remedial action that was effective for resolving the issue of another digital device can be recommended for the digital device (200) by its troubleshooting model (234) informed by the data warehouse (605).

FIG. 7 shows a computer system in accordance with one or more embodiments. Embodiments of the instant disclosure may be implemented on a computer system. For example, the digital device (200) can be a part of, or in some instances be considered as, a computer system. FIG. 7 is a block diagram of a computer system (702) used to provide computational functionalities associated with described algorithms, methods, functions, processes, flows, and procedures as described in the instant disclosure, according to an implementation. The illustrated computer (702) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or other suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), each computer (702) communicating over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

In some embodiments, the computer (702) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

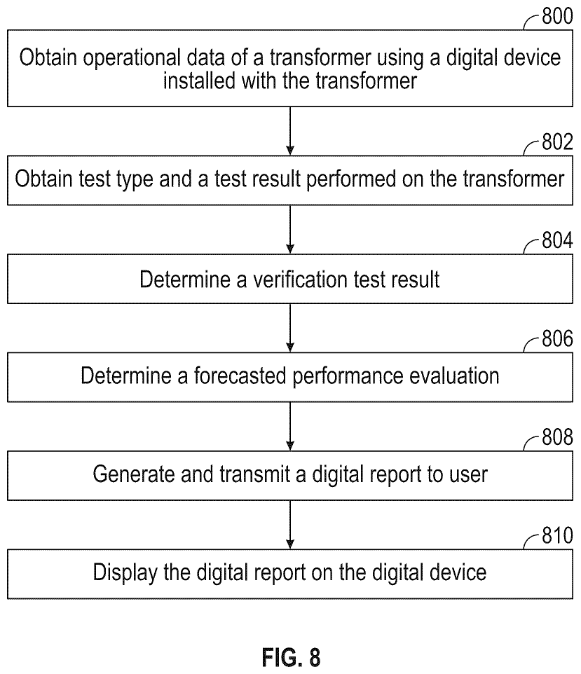

FIG. 8 shows a flow chart in accordance with one or more embodiments. Specifically, FIG. 8 describes a general method for inspecting a transformer (e.g., HV transformer (110)) performed with a digital device (e.g., digital device (160)) installed with the transformer. The digital device may be installed and disposed in an ingress protection 66 enclosure. One or more blocks in FIG. 8 may be performed by one or more components (e.g., digital device (160) and computer system (702)) as described in FIGS. 1-7. While the various blocks in FIG. 8 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 800, operational data of the transformer is obtained using the digital device by a database in the digital device. Operational data includes historical and current transformer data. Operational data may include temperature and power load data regarding the transformer. Operational data may further include manufacturing data, installation and operation data, maintenance stage data, and/or periodic inspection results data. In Block 802, test type and test results performed on the transformer are obtained. Test data including test type, time value, location, and inspector's name regarding the transformer may be obtained by the database. Identification data of a user may be obtained and uploaded via an identification card reader on the digital device. Access of the user may be managed to the digital device based on the identification data.

In Block 804, a verification test results is determined. The verification test result is determined by a test verification model. The verification test result includes a pass or fail diagnosis for the transformer based on the operational data and the performed test. In Block 806, a forecasted performance evaluation is determined. The forecasted performance evaluation is determined by a predictive model using an AI model based on operational data. The forecasted performance evaluation includes an alert regarding failure anticipation of the transformer. In response to a failed test result, a failed verification test result, or a forecasted performance evaluation failure, a root diagnosis may be determined using a troubleshooting model. The troubleshooting model may include an AI model. The root diagnosis identifies a failed component and recommends maintenance operations. The AI models used may include supervised learning algorithms.

In Block 808, a digital report is generated and transmitted to a user. The digital report may be transmitted using an LAN connection, a Wi-Fi connection, and/or a Bluetooth connection. The digital report includes test type, test result, verification test result, and forecasted performance evaluation. In some embodiments, the digital report includes the root diagnosis and/or test data. An email notification may be transmitted to the user or designated persons. The email notification may be sent via a network connection via LAN Cable, Wi-Fi, Bluetooth, etc., to transmit test results to the designated persons. In Block 810, the digital report is displayed by a user interface on the digital device. A QR code or bar code for the digital report may be displayed for the user on the digital device. In one or more embodiments, the QR code is for authentication to prevent data falsification, and is a process to ensure required tests are executed correctly and to minimize rework and forgery attempts. In some embodiments, the digital device includes a chatbot feature for assisting users.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A digital device, comprising:
a testing manager comprising a computer processor, wherein the testing manager is configured to:
obtain, via a database in the digital device, operational data of a transformer comprising historical transformer data and current transformer data for the transformer;
obtain a test type and a test result of a test performed on the transformer;
determine, via a test verification model, a verification test result comprising a pass or fail diagnosis for the transformer based on the operational data and the performed test;
determine, via a predictive model comprising an artificial intelligence (AI) model, a forecasted performance evaluation based on the operational data, wherein the forecasted performance evaluation comprises an alert regarding failure anticipation of the transformer; and
generate a digital report comprising the test type, the test result, the verification test result, and the forecasted performance evaluation; and
a user interface comprising a display; and
a transmitter configured to transmit the digital report,
wherein the digital device is disposed inside an enclosure on the transformer.

2. The digital device of claim 1, wherein the testing manager is further configured to:
determine, in response to a failed test result, a failed verification test result, or a forecasted performance evaluation failure, via a troubleshooting model comprising the AI model, a root diagnosis comprising a failed component identification and a maintenance recommendation,
wherein the digital report comprises the root diagnosis.

3. The digital device of claim 1, wherein the testing manager is further configured to:
obtain, via the database, test data comprising the test type, a time value, a location, and an inspector's name regarding the transformer,
wherein the digital report comprises the test data.

4. The digital device of claim 1, further comprising:
an identification card reader configured to manage access of a user to the digital device and upload identification data of the user to the digital device.

5. The digital device of claim 1, wherein operational data comprises temperature data and power load data regarding the transformer.

6. The digital device of claim 1, wherein the enclosure comprises an ingress protection 66 enclosure.

7. The digital device of claim 1, wherein operational data comprises manufacturing data, installation and operation data, maintenance stage data, and/or periodic inspection results data.

8. The digital device of claim 1, wherein the transmitter is configured to transmit the digital report via a local area network (LAN) connection, a wireless fidelity (Wi-Fi) connection, and/or a Bluetooth connection.

9. The digital device of claim 1, wherein the digital report is transmitted via an email to the user or displayed using a quick response (QR) code or bar code via the display.

10. The digital device of claim 1, wherein the AI model comprises a supervised learning algorithm.

11. A method for inspecting a transformer, the method performed by a digital device installed with the transformer, comprising:
obtaining, via a database in the digital device, operational data of the transformer comprising historical transformer data and current transformer data for the transformer;
obtaining a test type and a test result of a test performed on the transformer;
determining, via a test verification model, a verification test result comprising a pass or fail diagnosis for the transformer based on the operational data and the performed test;
determining, via a predictive model comprising an artificial intelligence (AI) model, a forecasted performance evaluation based on the operational data, wherein the forecasted performance evaluation comprises an alert regarding failure anticipation of the transformer;
generating a digital report comprising the test type, the test result, the verification test result, and the forecasted performance evaluation;
transmitting, via a transmitter of the digital device, the digital report to a user; and
displaying the digital report via a user interface on the digital device.

12. The method of claim 11, further comprising:
determining, in response to a failed test result, a failed verification test result, or a forecasted performance evaluation failure, via a troubleshooting model comprising the AI model, a root diagnosis comprising a failed component identification and a maintenance recommendation,
wherein generating the digital report comprises generating the root diagnosis.

13. The method of claim 11, further comprising:
obtaining, via the database, test data comprising the test type, a time value, a location, and an inspector's name regarding the transformer,
wherein generating the digital report comprises generating the test data.

14. The method of claim 11, further comprising:
obtaining identification data of the user with an identification card reader comprised by the digital device; and
managing access of the user to the digital device based on the identification data and uploading the identification data to the digital device.

15. The method of claim 11, wherein transmitting the digital report comprises transmitting an email to the user or displaying a QR code or bar code via a display.

16. The method of claim 11, wherein the operational data comprises temperature data and power load data regarding the transformer.

17. The method of claim 11, wherein the operational data comprises manufacturing data, installation and operation data, maintenance stage data, and/or periodic inspection results data.

18. The method of claim 11, wherein the digital device is installed in an ingress protection 66 enclosure.

19. The method of claim 11, wherein transmitting the digital report comprises transmitting via an LAN connection, a Wi-Fi connection, and/or a Bluetooth connection.

20. The method of claim 11, wherein the AI model comprises a supervised learning algorithm.
